(19) United States
(12) Patent Application Publication
(10) Pub. No.: US 2018/0003290 A1
(43) Pub. Date: Jan. 4, 2018

(54) GEAR UNIT FOR MOTOR VEHICLE

(71) Applicant: Ford Global Technologies, LLC, Dearborn, MI (US)

(72) Inventors: Michael Georg Figura, Dormagen (DE); Alexander Ein Waldt, Köln (DE); Armin Schymczyk, Solingen (DE); Gerhard Friedrich, Bornheim (DE)

(73) Assignee: Ford Global Technologies, LLC, Dearborn, MI (US)

(21) Appl. No.: 15/634,789

(22) Filed: Jun. 27, 2017

(30) Foreign Application Priority Data
Jun. 29, 2016 (DE) DE102016211706.8

(51) Int. Cl. F16H 57/12; F16H 1/16; F16H 57/021; B62D 5/04

(52) U.S. Cl. CPC F16H 57/12; F16H 57/021; F16H 1/16; B62D 5/04; F16H 2057/0213; F16H 2057/127

(57) ABSTRACT

A gear unit for a motor vehicle including an axially extending worm gear shaft, rotatable about a rotation axis, and cooperating with a worm gear wheel. The worm gear shaft supported, on one side of the worm gear wheel, through a first rotary bearing, on a housing and on the other side by of the worm gear wheel by a second rotary bearing loaded such that the worm gear shaft is pretensioned against the worm gear wheel. To optimize worm gear shaft and worm gear wheel engagement the first rotary bearing pivots or tilts relative to the housing, with deformation of at least one return element about a tilt axis perpendicular to the rotation axis. The return elements supporting the first rotary bearing on the housing in the axial and radial direction.

### CROSS-REFERENCE TO RELATED APPLICATIONS

Not Applicable.

### BACKGROUND OF THE INVENTION

### 1. Field of the Invention

The present invention relates generally to a gear unit for a motor vehicle; and more particularly, to a gear unit having a worm gear shaft rotatably supported about a rotation axis.

### 2. Description of Related Art

Modern motor vehicles are usually equipped with power-assisted steering, in which the driver's steering movements are supported by the vehicle and if necessary, the vehicle may generate a particular steering moment so as to point the driver to a recommended steering movement. As well as hydraulic power steering, above all motorized power steering systems are used. In the latter systems, usually an electric servo motor with a drive shaft acts on a worm gear shaft, which in turn cooperates with a worm gear wheel. The worm gear wheel sits on the actual steering shaft, which acts through a pinion on a steering rack. Similar systems with servo motor, worm gear shaft and worm gear wheel are also used in other areas of motor vehicles, e.g. window lifters.

Although theoretically, under ideal conditions, an optimum engagement with the worm gear wheel is possible with a worm gear shaft rotating around a fixed axis, in practice engagement may deteriorate due to production-induced or installation-induced inaccuracies, wear effects, soiling, and environmental influences such as moisture and temperature. The above influences, alone or in combination, may lead to the engagement between the worm gear shaft and worm gear wheel being too loose and/or too tight. Too tight an engagement is also a problem since it leads to increased friction, makes the gears difficult to move, and increases wear.

One method known in the prior art for alleviating such problems is to mount the worm gear shaft, on a side facing the drive shaft, with a first roller bearing, normally a ball bearing, that allows a degree of tilt or pivot movement transversely to the axial direction of the worm gear shaft. A second roller bearing, normally a ball bearing, mounts the opposite side of the worm gear shaft to a gear housing or structure through a spring. The spring exerts a bias, applies a load, on the worm gear shaft, in the direction of the worm gear wheel. The worm gear shaft pivots about the first roller bearing to remain in approximately constant engagement with the worm gear wheel.

One disadvantage is that the pivotability is usually only possible through a greater play in the region of the first roller bearing, leading to the possibility of vibrations and associated rattling noises, which are undesirable NVH aspects. The precision of the gear mechanism is also adversely affected because the axial and radio position of the worm gear shaft cannot be set precisely in the region of the first roller bearing. If bearing play is reduced in the region of the roller bearing, it usually leads to increased friction detracting from precision of control and leading to increased wear. Offsetting the action line of the force resulting from the engagement with the worm gear wheel on the worm gear shaft, towards the center axis of the latter, leads to a different level of friction and gear efficiency depending on the rotation direction of the worm gear shaft. This allows a degree of pivotability without the actual roller bearing needing unnecessary play, but the pivot axis is not defined precisely because of the structure of the pivot bearing. Also, the stiffness of the system against axial displacements is, in general, low and cannot be set in a targeted fashion. This in turn adversely affects the precision of the gear mechanism, and the engagement of the worm gear shaft with the worm gear wheel is not optimal. The engagement of the toothing under load is usually not optimal, and the corresponding gear play leads to audible and undesirable clattering noise.

### SUMMARY OF THE INVENTION

A gear unit for a motor vehicle comprising including a worm gear shaft rotatable about an axially extending rotation axis and a rotary bearing pivotable relative to a housing and supporting the worm gear shaft. A ring is positioned between the rotary bearing and housing, wherein the ring has a plurality of tangentially spaced, elastic radial protrusions, each protrusion extending between and engaging the housing and an outer bearing element of the rotary bearing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic cross-sectional view depicting an exemplary embodiment of a gear unit according to a first embodiment of the present invention.

FIG. 2 is a diagrammatic cross-sectional view depicting a part of a gear unit according to a second embodiment of the present invention.

FIG. 3 is a diagrammatic cross-sectional view depicting a part of a gear unit according to a third embodiment of the present invention.

FIG. 4 is a diagrammatic cross-sectional view depicting a part of a gear unit according to fourth embodiment of the present invention.

FIG. 5 is a diagrammatic cross-sectional view depicting a part of a gear unit according to fifth embodiment of the present invention.

FIG. 6 is a diagrammatic cross-sectional view depicting a part of a gear unit according to a sixth embodiment of the present invention.

FIG. 7 is a partial cross-sectional side view of a ring of the gear unit of FIG. 6.

FIG. 8 is a front view of another embodiment of the ring of FIG. 7

FIG. 9 is a partial cross-sectional side view of the ring of FIG. 8 taken along lines 9-9.

FIG. 10 is a partial cross-sectional side view depicting the ring of FIG. 8 according to a further embodiment.

### DETAILED DESCRIPTION OF THE PREFERRED EMBODIMENTS

The following description of the preferred embodiment(s) is merely exemplary in nature and is in no way intended to limit the invention, its application, or uses. In the different figures, identical parts are always provided with the same reference signs, and so said parts are generally also described only once.

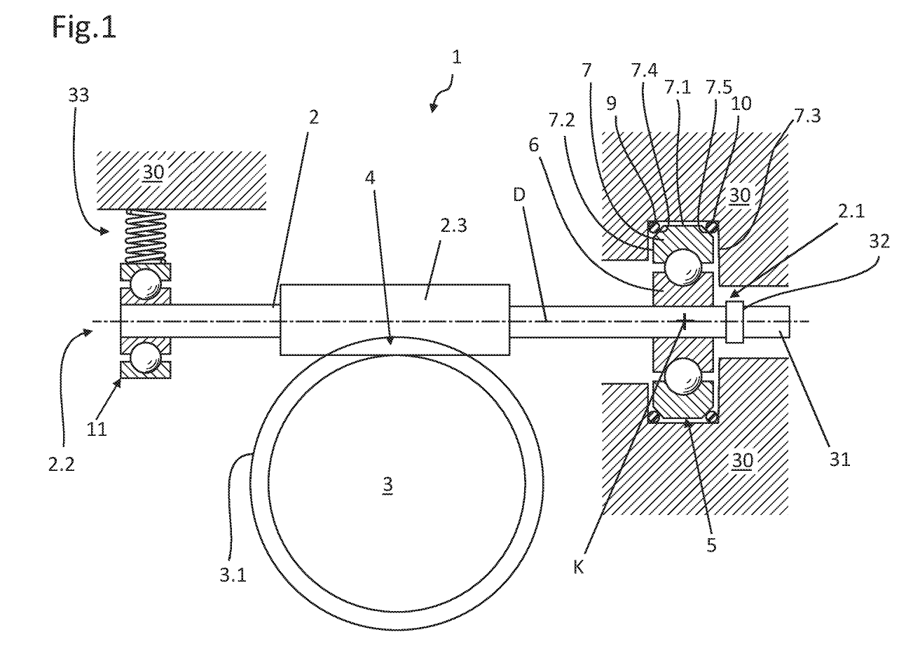

FIG. 1 shows, in a partial cross-sectional diagrammatic depiction, an exemplary embodiment of a gear unit 1 according to the invention used, for example, in a power steering system of a car. The diagrammatic depiction is partially simplified.

The gear unit 1 includes a worm gear shaft 2 mounted rotatably about a rotation axis D and a worm gear wheel 3. Both the worm gear shaft 2 and the worm gear wheel 3 are rotatably mounted relative to a housing 30. Although shown as one piece, the housing 30 may include several rigidly connected pieces. A worm screw 2.3 of the worm gear shaft 2 cooperates with a gear ring 3.1 of the worm gear wheel 3 in an engagement region 4. The worm gear shaft 3 is connected at a first end 2.1 thereof to a drive shaft 31 of a servo motor, not shown, via a clutch 32, indicated diagrammatically in FIG. 1.

A first ball bearing 5 and two rubber-elastic rings 9, 10 mount the worm gear shaft, in the region of the first end 2.1, on the housing 30. The first ball bearing 5 having an inner bearing ring 6 and an outer bearing ring 7. The two bearing rings 6, 7 positioned concentrically to the rotation axis D. The rings 9, 10 support the outer bearing ring 7 on the housing 30 in both the axial direction and the radial direction. The rings 9, 10 engage the outer bearing ring 7 in transitional regions 7.4, 7.5 situated at a transition between a radially outer casing region 7.1 and the end regions 7.2, 7.3 lying axially in front and behind. The transitional regions 7.4, 7.5 are beveled or chamfered between the casing region 7.1 and the end regions 7.2, 7.3 to better hold the rings 9, 10, which have a circular cross-section. Alternatively, the transitional regions 7.4, 7.5 could also have a concave form. Because the rings 9, 10 are elastic, they do not fix or fully establish the radial and axial position of the first ball bearing 5, the first ball bearing 5 may move or deflect to the deformability of the rings 9, 10. The rings 9, 10 create a degree of pivotability associated with an elastic deformation of the rings 9, 10. Although the first ball bearing 7 is configured substantially without play, the worm gear shaft 2 together with the ball bearing 7 may be tilted or pivot about the tilt or pivot axis K intersecting the rotation axis D and extending perpendicular thereto.

At a second end 2.2, opposite the first end 2.1, the worm gear shaft 2 is mounted in a second ball bearing 11 connected to a housing 30 through a spring 33, depicted here diagrammatically. The spring 33 pretensions the worm gear shaft 2 against the worm gear wheel 3. In connection with the tiltable or pivotable mounting of the worm gear shaft 2, the spring 33 helps provide optimal engagement between the worm gear shaft 2 and the worm gear wheel 3. Using the rubber elastic rings 9, 10 provides substantially play-free configuration whereby the precision and efficiency of the gear unit 1 are not reduced. Further, the elastic support of the first ball bearing 5 via the rubber-elastic rings 9, 10 largely excludes knocking of the first ball bearing 5 on the housing 30 and correspondingly reducing occurrence of disruptive noise.

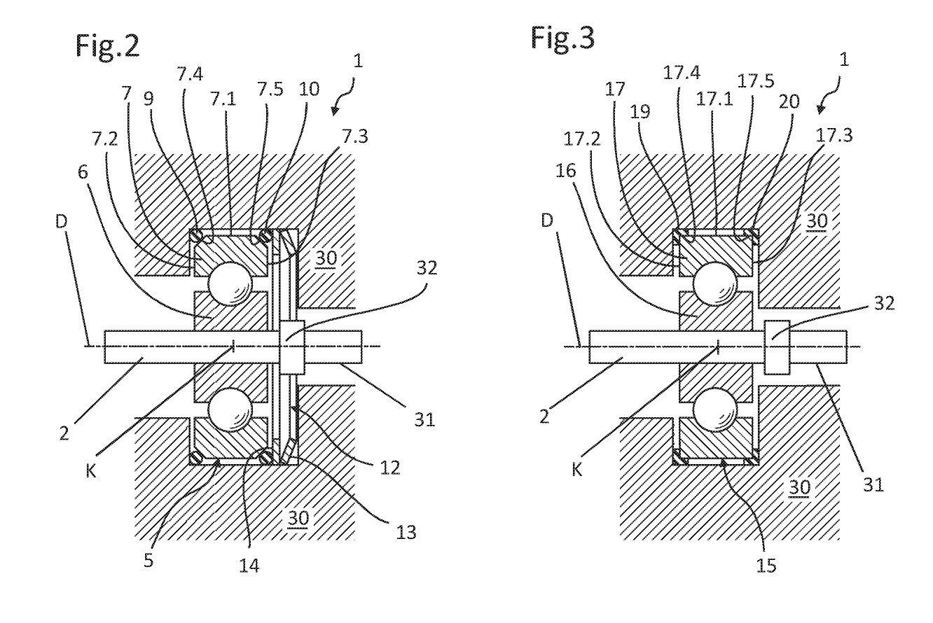

FIG. 2 illustrates an additional embodiment of a gear unit 1 according to the invention. The rubber-elastic ring 10 is loaded in the axial direction by a spring arrangement 12 and thus pretensioned, providing compensation for temperature-induced changes in the volume and elasticity of the rings 9, 10. The spring arrangement 12 includes a cup spring 13 resting on the housing 30 and acting on an annular spacer washer 14, providing force distribution. The spacer washer 14 directly engaging the rubber-elastic ring 10.

FIG. 3 illustrates a third embodiment of a gear unit 1 according to the invention. A first ball bearing 15 is provided with an inner bearing ring 16 and an outer bearing ring 17, the outer bearing ring not chamfered in the transitional regions 17.4, 17.5 between the casing region 17.1 and end regions 17.2, 17.3. Rubber-elastic rings 19, 20 having an L-shaped cross-section are form fit in the transitional regions 17.4, 17.5. The rings 19, 20 may be produced separately and on assembly, inserted between the housing 30 and the outer bearing ring 17 of the first ball bearing 15. It is also possible that the rubber-elastic rings 19, 20 are vulcanized directly onto the outer bearing ring 17 or otherwise connected thereto by suitable means such as substance bonding.

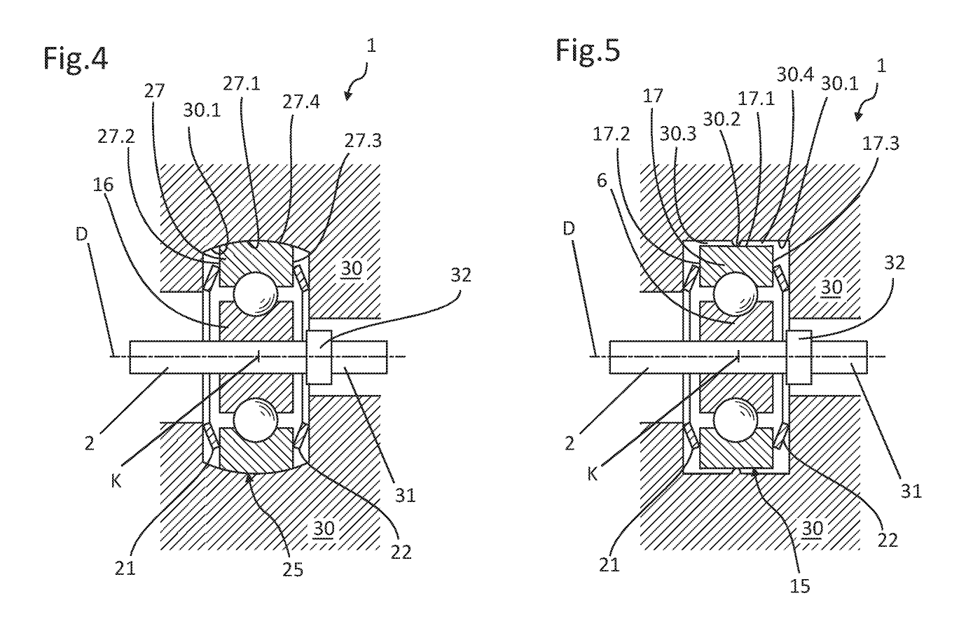

FIG. 4 illustrates a fourth embodiment of a gear unit 1 according to the invention. As shown, an outer bearing ring 27 of a first ball bearing 25 has, on a casing surface 27.1, a convex outer face 27.4 configured as a portion of the outer bearing ring 27 surface. The convex outer face 27.4 received in a concave inner face 30.1 of a housing 30, wherein the form and dimension of the inner face 30.1 correspond to the outer face 27.4. End regions 27.2, 27.3 of the outer bearing ring 27, located axially on both sides, are loaded by cup springs 21, 22 positioned between the ball bearing 25 in the housing 30 on both sides of the bearing 25 and supported by the housing 30. This arrangement enables a tilt or pivot movement of the rotary bearing 25 and correspondingly, the worm gear shaft 2 supported thereby, about the tilt or pivot axis K. The elastic cup springs 21, 22 deform when the worm gear shaft pivots about the pivot axis K and create a return torque. The matching of the outer face 27.4 and the inner face 30.1, provide a substantially play-free retention in the radial direction, which in turn has a positive effect on the precision of the gear unit 1 and helps prevent noise development.

FIG. 5 illustrates a fifth embodiment of a gear unit 1 according to the invention. The ball bearing 15, like that shown in FIG. 3 has an outer bearing ring 17 with a single cylindrical casing face 17.1. To achieve a desired tilt movement about the tilt or pivot axis K and not to allow unnecessary play in the radial direction, the inner face 30.1 of the housing 30 has a peripheral, inwardly directed protrusion 30.2. The inwardly directed protrusion 30.2 supports the casing face 17.1 of the first ball bearing 15. During a tilt or pivot movement, the outer bearing ring 17 of the ball bearing 15 moves into the regions 30.3, 30.4 lying axially to the side of the protrusion 30.2 formed by the inner face 30.1 located radially outwardly behind the protrusion 30.2. The protrusion 30.2 need not be tangentially fully peripheral, extend entirely along the periphery of the inner face 30.1, but may be interrupted, or be a plurality of tangentially spaced protrusions 30.2.

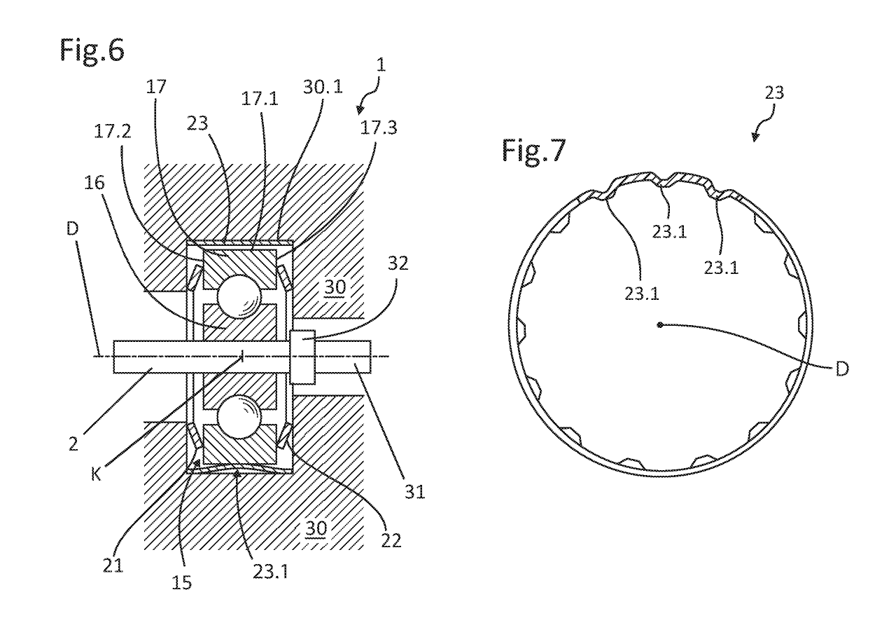

FIG. 6 illustrates a sixth embodiment of a gear unit 1 according to the invention. As shown, the inner face 30.1 of the housing 30 is configured as a cylinder casing, i.e. has no protrusion. Instead, a tolerance ring 23 in the form of a cylinder casing annular member is arranged between the outer bearing ring 17 of the ball bearing 15 and the interface 30.1 of the housing 30. As illustrated in FIG. 7 the tolerance ring 23 when viewed along the rotation axis D, includes a plurality of tangentially spaced elastic protrusions 23.1. These protrusions 23.1 extend radially inward and may be formed during forming of the tolerance ring 23. As shown in FIG. 7 the protrusions 23.1, like the rest of the tolerance ring 23, have a substantially constant thickness. In one example, the tolerance ring 23 may be made from a metal sheet having a constant thickness. The tolerance ring 23 may also be configured with a C-shaped, not closed, and configured to provide a predetermined radial stiffness between the ball bearing 15 and the housing 30. Similar to the embodiment of FIG. 5 the cup springs 21, 22 deform when the worm gear shaft pivots about the pivot axis K and create a return torque and the elasticity of the protrusions 23.1 may assist the cup springs 21, 22 in generating a return torque.

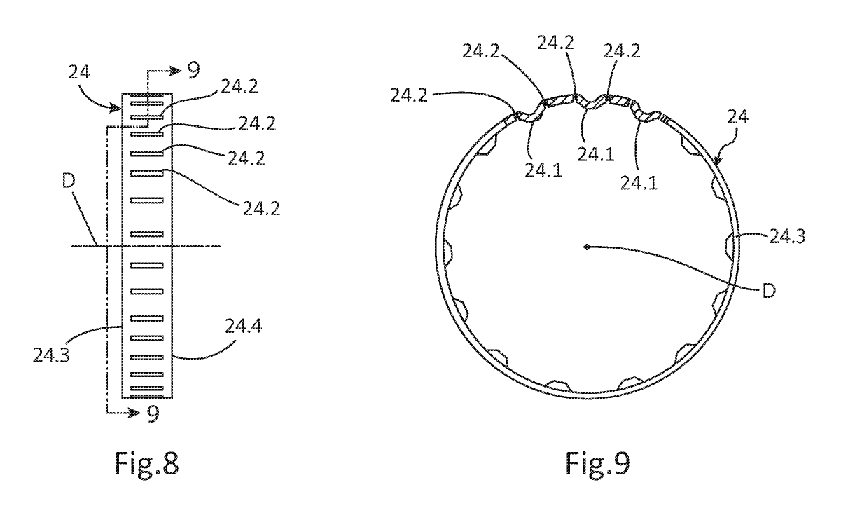

FIGS. 8 and 9 illustrate an alternate embodiment of a tolerance ring, seen generally at 24, providing an additional embodiment of a gear unit 1 according to the invention similar to that shown in FIG. 6. The tolerance ring 24 also has a plurality of protrusions 24.1 lying on the inside, extending radially inwardly from the inner circumferential surface. Continuous slots 24.2 are provided tangentially on either side of each protrusion 24.1, the slots 24.2 extending axially, parallel to the rotation axis D, between the respective sides 24.3, 24.4 of the tolerance ring 24 making each of the protrusions 24.1 more elastic or softer than the protrusions 23.1. The precise amount of elasticity may be influenced by various parameters, for example by the axial extension of the slots 24.2, their tangential extension and their mutual spacing, which again is connected to the tangential extension of each of the protrusions 24.1. The slots 24.2 may for example be punched or milled out.

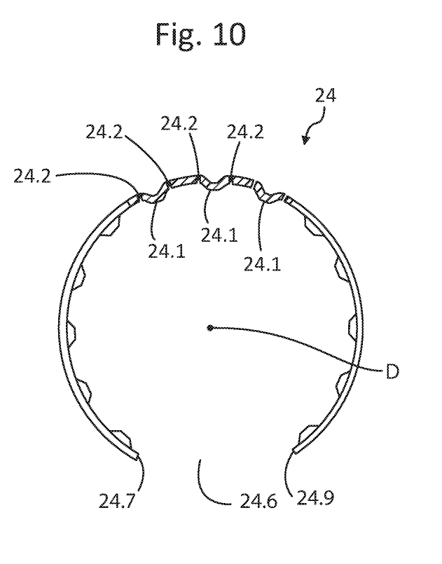

FIG. 10 illustrates a further exemplary embodiment of the tolerance ring 24, similar to that of FIG. 9 wherein the tolerance ring 24 has an opening 24.6 between ends 24.7, 24.9. Accordingly, the tolerance ring 24 has a generally C-shaped configuration. In comparison with the embodiment of FIG. 8, removal of a peripheral element from the tolerance ring 24, which may be achieved by cutting or directly during production, provides additional tolerance. The opening 24.6 may have dimensions and position suitable in the sense of the invention.

The gear unit 1 may be used in a motor vehicle, in particular private cars and commercial vehicles. In one example, the gear unit 1 may be a gear unit for a power steering system, although other applications are possible, for example, window lifters, electric seat adjustment mechanisms, or other movable mechanisms.

The gear unit 1 has an axially extending, rotatable worm gear shaft 2, rotatable about an axially extending rotation axis D, that cooperates with a worm gear wheel 3. The axial direction of the rotation axis D defines the radial and tangential directions mentioned below. The worm gear shaft 2 is normally coupled, directly or indirectly, to a drive shaft 31 of a servo motor extending approximately coaxially. A clutch or clutch arrangement 32 transmits a torque from the driveshaft 31 to the worm gear shaft 2. The worm gear shaft 2 engaging the worm gear wheel 3 whereby rotary motion of the drive shaft 31 is stepped down.

The worm gear shaft 2 is shown mounted on a housing 30 on one side 2.1 of the worm gear wheel 3 with a first rotary bearing 5 and on the other side 2.2 with a second rotary bearing 11. As shown, the second rotary bearing 11 can be preloaded or pretensioned by a spring 33 such that the worm gear shaft 2 is pretensioned or biased against the worm gear wheel 3. The housing 30 forms a reference frame normally stationary relative to the vehicle, through which the relative positions of the movable gear components are at least partially defined. The housing 30 may be made of one piece or be multipiece. It may be configured open to a varying extent, in which case it could also be described as a “frame” or similar. It is also possible that the gear components mentioned, where applicable together with further gear components, are largely surrounded by the housing 30. The worm gear shaft 2 is supported by the first and second rotary bearings 5, 11 and rotates relative to the housing 30. The rotary bearings 5, 11 are normally roller bearings, in particular ball bearings; however at least one of the rotary bearings may be configured as a plain bearing. The two rotary bearings 5, 11 are located on either side of the worm gear wheel or an engagement region in which the worm gear shaft 2 cooperates with the worm gear wheel 3. The worm gear wheel 3 or the engagement region is situated between the two rotary bearings 5, 11 along the worm gear shaft 2. Normally, the rotary bearings 5, 11 are situated at opposite ends 2.1, 2.2, or in the region of opposite ends 2.1, 2.2 of the worm gear shaft 2.

The second rotary bearing 11 may be loaded by a pretensioning element to urge or bias the worm gear shaft 2 against the worm gear wheel 3. The second rotary bearing 11 may be loaded for example using an elastic pretension element arranged between the housing 30 and the second rotary bearing 11. The elastic pretension element may include a spring made of metal or fiber-reinforced plastic, or an element consisting of an elastomer. The pretension of the rotary bearing 11 defines a pretension of the worm gear shaft 2 in the direction towards the worm gear wheel 3. The corresponding pretension acts to ensure that the worm gear shaft 2 remains in engagement with the worm gear wheel 3, wherein the pretension element, because of its elastic property, may provide a degree of deflection to the worm gear shaft 2, whereby the friction forces between the worm gear shaft two and the worm gear wheel three may be limited. The second rotary bearing 11 may in particular be configured as a loose bearing which can move within a certain range at least in the direction of the spacing axis.

The first rotary bearing 5 tilts or pivots relative to the housing 30, deforming at least one return element, for example rubber-elastic ring 9, 10, about a tilt or pivot axis K perpendicular to the rotation axis D. The first rotary bearing 5 is fixed on the housing 30 but has at least slight pivotability relative thereto. The terms “tilt” and “pivot” should here be understood synonymously. As illustrated, the entire rotary bearing 5 pivots or is tiltable, typically with a roller bearing pivotability between the inner bearing ring and outer bearing ring is normally achieved through increased play in the roller bearing, which adversely affects the precision of the bearing and hence of the entire gear unit and can lead to undesirable noise development. As shown, the pivoting or tilting takes place with deformation of at least one return element, for example deformation of the rubber-elastic ring 9, 10. The rotary bearing 5 is not freely movable relative to the housing 30, rather, at least one return element is deformed, which serves to improve the positioning of the bearing 5 relative to the housing 30 and to suppress uncontrolled movement the meeting to knocking and noise development, whereby undesirable loosening is also avoided and freedom of play is created. The return element, for example the rubber-elastic ring 9, 10; the rubber-elastic elements 19, 20 having an L-shaped cross-section; and the spring arrangement 12, including 13, 21, and 22 all exert a return force or return torque on the rotary bearing 5. The return element absorbing axial and/or radial forces and contributing to setting the stiffness of the system in the corresponding direction. At least one return element is ideally arranged between the first rotary bearing 5 and the housing 30, in some cases with the interposition of at least one further component. Preferably, the return element or elements are arranged symmetrically to the rotation axis.

As return elements, the rubber-elastic elements 9, 10, 19, 20 are arranged in the transition regions between a casing face and end faces of the first rotary bearing 5, wherein they are supported at least indirectly on the housing 30 in the axial and radial direction. Preferably, each of the rubber-elastic elements is supported both axially and radially. The casing face 7.1 of the outer bearing ring 7 is the radially outer side, and the end faces 7.2, 7.3 are the faces lying axially in front and behind. The transitional regions 7.4, 7.5 may here comprise parts of the casing face which join the end face, and/or parts of the end faces which join the casing face. It is also possible that a part of such a transitional region cannot be clearly assigned to the casing face or end face, but to a certain extent is arranged in between. The rubber-elastic element may be made of rubber or another elastomer, e.g. silicone. A composite construction, where applicable with non-elastic part regions, is also conceivable. Preferably, such a rubber-elastic element is arranged such that the first rotary bearing 5 is supported thereby on the housing both radially and axially, so that both radial and axial forces are transmitted between the rotary bearing 5 and the housing 30. The support may here take place in some cases indirectly via an interposed further component. The rubber-elastic elements may be fully or partially peripheral in the tangential direction, for example rubber-elastic rings or ring portions. A fully peripheral ring may include recesses, not continuous axially. Insofar as the rotary bearing is a roller bearing with an inner bearing ring and an outer bearing ring, the return elements may be arranged in transitional regions between a casing face and the end faces of the outer bearing ring.

The rubber-elastic elements 19, 20 are shown having an L-shaped cross section. In other words, in cross-section, two legs may be distinguished, one of which is arranged on the casing face 17.1 and the other on an end face 17.2, 17.3. As a derivative of the L-shape, a slight rounding may be provided to a form which could be described as a quadrant shape. The rubber-elastic elements preferably create an interference fit to the first rotary bearing 5 and in some cases the attached to the rotary bearing 5 by substance bonding or be vulcanized directly onto the rotary bearing 5. It is also possible that in a rubber-elastic element, the actual elastic layer is applied onto a carrier layer formed from metal or plastic. In this way, the force distribution and deformation behavior can be influenced as desired.

Alternatively, the rubber-elastic elements may have a circular cross section for example the rubber elastic rings 9, 10. These may for example be conventional O-rings, but other structures are also conceivable in which a rubber-elastic element is not tangentially fully peripheral. In order to guarantee a secure positioning of such rubber-elastic elements in the transitional region, it is preferred that a surface of the first rotary bearing 5 runs at an angle to the axial direction and to the radial direction wherein the corresponding region is beveled or chamfered towards both the casing face and the end face. It would also be conceivable to provide a peripheral groove for receiving the rubber-elastic elements, for example a concave depression or groove.

The volume and/or elasticity of rubber-elastic materials are relatively greatly dependent on ambient temperature which may have a disadvantageous effect on the reproducibility of a return force. In one exemplary embodiment, a spring arrangement 12 is provided on one side of the bearing 5. The spring arrangement 12, positioned between at least one rubber-elastic element and the housing to generate a pretension acting in the axial direction. The spring arrangement 12, including at least one spring element made of metal or fiber reinforced plastic, loads the rubber-elastic element in the axial direction and holds it under a certain pretension, which significantly reduces the temperature-dependence of the return force generated. Because the spring element 12 is formed of a material which is not rubber-elastic, the spring element 12 is significantly less temperature-dependent. The spring element may be an annular, tangentially peripheral spring, e.g. a cup spring, belleville washer or wave washer. For more even pressure distribution, a disc-like intermediate element which is substantially non-elastic may be arranged between the rubber-elastic element and the spring element.

As shown, the spring arrangement 12 may include partially peripheral spring elements are arranged in the axial direction between the end faces of the first rotary bearing 5 and the housing 30. In the case of a roller bearing, the return elements are arranged between the end faces of the outer bearing ring and the housing. The spring elements may in turn be made of metal or fiber-reinforced plastic and have the form of closed or open rings. They may be cup springs or wave washers. The spring elements may in particular be arranged on the edge of the respective end face, i.e. in the transitional region to the casing face, or lie against the first roller bearing. They load the rotary bearing at the edge in the axial direction, creating a return force against axial displacements and a return torque against a pivot movement of the first rotary bearing 5 about a tilt or pivot axis K. Generally, the first rotary bearing 5 needs, in addition to the support in the axial direction, to be mounted or supported in the radial direction in a manner allowing a certain degree of positional security that does not detract from pivot ability or tiltability.

In another exemplary embodiment, the first rotary bearing, or in the case of a roller bearing, the outer bearing ring, has a convex outer face received in a corresponding concave inner face of the housing. In cross-section, the respective outer or inner face faces corresponds approximately to a circle having a center point in the center of the rotary bearing, on the rotation axis. In one example, the outer face or inner face may correspond to a portion of a ball surface, whereby in principle pivotability about any axis would be possible.

In a further embodiment, an inwardly directed protrusion, may extend inwardly from an inner face of the housing. For example, a peripheral or partially pronounced ring bead, on which the casing face of the first rotary bearing lies. Such a protrusion could also be called an inner rib. Its axial extension or width significantly less than the width of the rotary bearing. Wherein, due to such a protrusion, the first rotary bearing is supported more through a line than through a large surface. Because the protrusion is thinner, or of less width, on both sides of the protrusion, there are regions extending rearwardly, in relative terms, radially outwardly from the bearing and into which the rotary bearing may at least partially move inward upon pivoting or tilting. The protrusion may be made integrally with adjacent regions of the housing, and to this extent is substantially non-elastic. It may be interrupted in the tangential direction, or a series of tangentially spaced protrusions may alternate with each other.

In a further embodiment, a peripheral ring, in the form of a cylindrical casing, is arranged radially between the first rotary bearing and the housing. The peripheral ring having a plurality of tangentially spaced, elastic radial protrusions. The ring may be referred to as a tolerance ring. The ring may be formed open or closed. If the ring is open, greater tolerances can be achieved. In particular, the ring may be made of sheet metal or a comparable material with elastic properties, or also from a composite material. The protrusions may in particular be produced by forming, for example, by embossing a sheet. The protrusions protruding radially, wherein all protrusions may point radially inward or radially outward, or some protrusions may point inward and others outward, in some cases alternatively. The stiffness of the material, and in particular the return force acting on deformation, may be set by the thickness and elasticity of the material and by the shape of the protrusions. The protrusions enable pivoting or tilting of the first rotary bearing, along with establishing the stiffness or elasticity of the connection in the radial direction.

The stiffness of the individual protrusions may be further influenced if the ring has at least one recess adjacent to at least one protrusion. In the case of a sheet metal, such a recess may be punched, milled or cut out. Normally, the recesses are continuous in the radial direction. Pairs of recesses may be provided on either side of a protrusion. In particular, a recess may be arranged tangentially laterally relative to the protrusion.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gear unit for a motor vehicle comprising:
a worm gear wheel;
a worm gear shaft rotatable about an axially extending rotation axis; said worm gear shaft mounted on one side of said worm gear wheel through a first rotary bearing and on the other side by a second rotary bearing;
said first rotary bearing pivotable relative to the housing about a pivot axis perpendicular to the rotation axis, and
a return element arranged between said rotary bearing and said housing and supporting said rotary bearing on the housing in an axial and a radial direction.

2. The gear unit of claim 1 wherein the return element is a rubber-elastic element having an L-shaped cross section.

3. The gear unit of claim 1 wherein the return element is a rubber-elastic element having a circular cross section.

4. The gear unit of claim 1 wherein the return element is a rubber-elastic element arranged in a transitional region extending between a casing face and an end face of an outer bearing ring of said first rotary bearing, said transitional region including a surface extending transverse to both said casing face and said end face wherein said rubber-elastic element engages both said housing and said surface.

5. The gear unit of claim 4 including a spring arrangement positioned between said rubber-elastic element and said housing.

6. The gear unit of claim 1 wherein said return element includes a spring element arranged in an axial direction between an end face of the first rotary bearing and the housing; and
a ring in the form of a cylindrical casing arranged radially between said first rotary bearing and said housing, said ring having a plurality of tangentially spaced, elastic radial protrusions, each protrusion extending between and engaging said housing and a casing face of an outer bearing element.

8. The gear unit of claim 6 wherein said ring has at least one recess adjacent to at least one protrusion.

9. The gear unit of claim 6 including a first spring element arranged in an axial direction between a first end face of said rotary bearing and said housing and a second spring element arranged in an axial direction between a second end face of said rotary bearing and said housing.

10. A gear unit for a motor vehicle comprising:
a worm gear wheel;
a worm gear shaft rotatable about an axially extending rotation axis, said worm gear shaft mounted on one side of said worm gear wheel through a first rotary bearing and on an opposing side by a second rotary bearing;
said first rotary bearing pivotable relative to the housing about a pivot axis perpendicular to the rotation axis;
a return element between said first rotary bearing and said housing and supporting said first rotary bearing on said housing in the axial direction; and
a ring disposed between a casing face of said first rotary bearing and the housing, said ring having a plurality of tangentially spaced, elastic radial protrusions, each protrusion extending between and engaging said housing and a casing face of said first rotary bearing.

11. The gear unit of claim 10 wherein said ring has at least one recess adjacent to at least one protrusion.

12. The gear unit of claim 10 wherein said recesses extend tangentially, in the direction of a pivot axis.

13. The gear unit of claim 10 wherein said ring has an open configuration forming a C-shape in the direction of the pivot axis.

14. The gear unit of claim 10 wherein said return element includes a spring element arranged in the axial direction between an end face of the first rotary bearing and the housing.

15. The gear unit of claim 10 wherein the return element is a rubber-elastic element.

16. A gear unit for a motor vehicle comprising:
a worm gear shaft rotatable about an axially extending rotation axis;
a rotary bearing pivotable relative to a housing and supporting said worm gear shaft; and
a ring having a plurality of tangentially spaced, elastic radial protrusions, and at least one recess adjacent to at least one protrusion, each protrusion extending between and engaging the housing and an outer bearing element of said rotary bearing.
